(19) United States
(12) Patent Application Publication
(10) Pub. No.: US 2017/0334293 A1
(43) Pub. Date: Nov. 23, 2017

(54) VEHICULAR DISPLAY DEVICE

(71) Applicant: TOYOTA JIDOSHA KABUSHIKI KAISHA, Toyota-shi (JP)

(72) Inventors: Masashi KAWAMOTO, Okazaki-shi (JP); Takayuki AOKI, Toyota-shi (JP)

(73) Assignee: TOYOTA JIDOSHA KABUSHIKI KAISHA, Toyota-shi (JP)

(21) Appl. No.: 15/497,712

(22) Filed: Apr. 26, 2017

(30) Foreign Application Priority Data
May 18, 2016 (JP) 2016-099957

(51) Int. Cl. B60K 37/02; G02B 5/02

(52) U.S. Cl. CPC B60K 37/02; G02B 5/0278; B60K 2350/203; B60K 2350/2052

(57) ABSTRACT

A vehicular display device includes: a decoration panel that includes a base, the base including one surface thereof configured as a design surface and an opening formed therein, and the decoration panel being provided at an interior in a vehicle; a diffusion member that is configured to block the opening of the base; and a sheet member that includes a light transmission type screen portion, the light transmission type screen portion including a light transmitting portion and a light shielding portion mixed therein, the light transmitting portion being configured such that light that has been irradiated from a side of another surface of the base to be diffused by the diffusion member is transmitted, and the light shielding portion being configured such that the light cannot be transmitted, and the sheet member being provided on the design surface such that the light transmission type screen portion covers the diffusion member.

### CROSS-REFERENCE TO RELATED APPLICATION

This application is based on and claims priority under 35 USC 119 from Japanese Patent Application No. 2016-099957 filed on May 18, 2016, the disclosure of which is incorporated by reference herein.

### BACKGROUND

### Technical Field

The present disclosure relates to a vehicular display device.

### Related Art

An advertisement sheet configured such that when a film having opacifying properties and including minute holes and on whose surface an image is printed and that is attached to a transmission type screen, is viewed from its surface, that printed image can be seen, and when an another image is projected from a reverse side of the film, that projected other image can be seen from the surface, is conventionally known (for example, refer to Japanese Patent No. 4680488).

However, when such an advertisement sheet is applied to a decoration panel provided as an interior of a vehicle, it becomes necessary to take measures against problems such that rigidity of the advertisement sheet is low due to it being a sheet-like member, and that appearance of a design surface side of the decoration panel is impaired by presence/absence of the minute holes set in a range that the image is projected.

### SUMMARY

The present disclosure provides a vehicular display device in which when a decoration panel whose one surface is configured as a design surface is irradiated by light from a side of its other surface, part of that design surface becomes a screen and may thereby display the likes of an image or illumination.

A first aspect of the present disclosure is a vehicle display device including: a decoration panel that includes a base, the base including one surface thereof configured as a design surface and the base including an opening formed therein, and the decoration panel being provided at an interior in a vehicle; a diffusion member that is configured to block the opening of the base; and a sheet member that includes a light transmission type screen portion, the light transmission type screen portion including a light transmitting portion and a light shielding portion mixed therein, the light transmitting portion being configured such that light that has been irradiated from a side of another surface of the base to be diffused by the diffusion member is transmitted, and the light shielding portion being configured such that the light cannot be transmitted, and the sheet member being provided on the design surface such that the light transmission type screen portion covers the diffusion member.

According to the above-described aspect, an opening is formed in a base of a decoration panel provided at an interior in a vehicle, and a diffusion member is provided in the base so as to block the opening. Moreover, a design surface which is one surface of the base is provided with a sheet member that includes a light transmission type screen portion that has mixed therein a light transmitting portion configured such that light that has been irradiated from a side of the other surface of the base to be diffused by the diffusion member may be transmitted, and a light shielding portion configured such that that the light may not be transmitted, and the design surface is provided with the sheet member such that that light transmission type screen portion covers the diffusion member.

Therefore, in the decoration panel, part of the design surface which is one surface of the base, that is, the light transmission type screen portion in the sheet member provided on the design surface becomes a screen to be displayed with the likes of an image or illumination, when light is irradiated from the side of the other surface of the base. Note that “design surface” in the present disclosure is, as described above, one surface of the base provided with the sheet member, and is a surface exposed to the inside of a vehicle interior, excluding a region where the sheet member has been provided.

In this way, according to the first aspect, when the decoration panel whose one surface has been configured as the design surface has been irradiated by light from the side of its other surface, part of that design surface becomes a screen and may thereby display the likes of an image or illumination.

In the first aspect, a region where the light transmission type screen portion is formed may be in a range that is broader than the diffusion member, and narrower than an external form of the sheet member.

According to the above-described configuration, a region where the light transmission type screen portion is formed is set in a range which is broader than the diffusion member, and narrower than an external form of the sheet member. Therefore, the sheet member is manufactured at lower cost, compared to a configuration in which the light transmission type screen portion is formed on an entire surface of the sheet member. Moreover, even if a position of the sheet member is somewhat misaligned when it is provided on the design surface of the base, the diffusion member is covered by the light transmission type screen portion. Hence, even the decoration panel provided with the sheet member has its positional accuracy relaxed, and is thus easily manufactured.

In the first aspect, the sheet member may be configured by a light shielding film being deposited on a light transmitting film, the light transmitting portion may be configured by numerous micropores that penetrate the light transmitting film and the light shielding film, and the light shielding portion may be configured by the light shielding film.

According to the above-described configuration, the sheet member is configured by a light shielding film being deposited on a light transmitting film, the light transmitting portion is configured by numerous micropores that penetrate the light transmitting film and the light shielding film, and the light shielding portion is configured by the light shielding film. In other words, a region where numerous micropores are formed is set in a range which is broader than the diffusion member, and narrower than an external form of the sheet member. Therefore, the sheet member is manufactured at lower cost, compared to a configuration in which numerous micropores are formed on an entire surface of the sheet member. Note that “micropore” in the present disclosure refers to a minute through hole difficult to be seen with the naked eye, and the same applies also to “micropore” and “dummy micropore” hereafter.

In the first aspect, the sheet member may be configured by a panel made of a metal, the light transmitting portion may be configured by numerous micropores that penetrate the panel, and the light shielding portion may be configured by the panel.

According to the above-described configuration, the sheet member is configured by a panel made of a metal, the light transmitting portion is configured by numerous micropores that penetrate the panel, and the light shielding portion is configured by the panel. In other words, a region where numerous micropores are formed is set in a range which is broader than the diffusion member, and narrower than an external form of the sheet member. Therefore, the sheet member is manufactured at lower cost, compared to a configuration in which numerous micropores are formed on an entire surface of the sheet member.

In the first aspect, the sheet member may include a gradual variation portion that includes plural dummy micropores formed with a pitch larger than that of the micropores, at a periphery of the light transmission type screen portion.

According to the above-described configuration, a gradual variation part that includes plural dummy micropores formed with a pitch larger than that of the micropores, is provided in the sheet member in a periphery of the light transmission type screen portion. Therefore, when viewed from a design surface side of the decoration panel, a boundary between a region where micropores are formed and a region where micropores are not formed becomes indistinct. Hence, impairment of appearance of the design surface of the decoration panel is suppressed.

In the first aspect, a pitch of the dummy micropores may be made larger with increasing distance from the diffusion member.

According to the above-described configuration, a pitch with which the dummy micropores are formed is made larger with increasing distance from the diffusion member. Therefore, when viewed from a design surface side of the decoration panel, a boundary between the region where micropores are formed and the region where micropores are not formed becomes even more indistinct. Hence, impairment of appearance of the design surface of the decoration panel is further suppressed.

In the first aspect, the diffusion member may be made flush with the design surface of the base.

According to the above-described configuration, the diffusion member is made flush with the design surface of the base. In other words, the design surface of the decoration panel is configured as a stepless smooth surface. Therefore, appearance of the design surface of the decoration panel is improved.

A second aspect of the present disclosure is a vehicular display device including: a decoration panel that includes a base, the base including one surface thereof configured as a design surface and the base including an opening formed therein, and the decoration panel being provided at an interior in a vehicle; a transparent member that is configured to block the opening of the base; and a diffusion member that includes a light transmission type screen portion, the light transmission type screen portion including a light transmitting portion and a light shielding portion mixed therein, the light transmitting portion being configured such that light that has been irradiated from a side of another surface of the base to be transmitted through the transparent member is diffused and the diffused light is transmitted, and the light shielding portion being configured such that the light cannot be transmitted, and the diffusion member being provided on the design surface such that the light transmission type screen portion covers the transparent member.

According to the second aspect, an opening is formed in a base of a decoration panel provided at an interior in a vehicle, and a transparent member is provided in the base so as to block the opening. Moreover, a design surface which is one surface of the base is provided with a diffusion member that includes a light transmission type screen portion that has mixed therein a light transmitting portion configured such that light that has been irradiated from a side of the other surface of the base to be transmitted through the transparent member may be diffused and that diffused light may be transmitted, and a light shielding portion configured such that the light may not be transmitted, and the design surface is provided with the diffusion member such that that light transmission type screen portion covers the transparent member.

Therefore, in the decoration panel, part of the design surface which is one surface of the base, that is, the light transmission type screen portion in the diffusion member provided on the design surface becomes a screen to be displayed with the likes of an image or illumination, when light is irradiated from the side of the other surface of the base. Note that “design surface” in the present disclosure is, as described above, one surface of the base provided with the diffusion member, and is a surface exposed to the inside of a vehicle interior, excluding a region where the diffusion member has been provided.

In this way, according to the second aspect, when the decoration panel whose one surface has been configured as the design surface has been irradiated by light from the side of its other surface, part of that design surface becomes a screen and may thereby display the likes of an image or illumination.

### BRIEF DESCRIPTION OF THE DRAWINGS

Exemplary embodiments of the present disclosure will be described in detail based on the following figures, wherein:

FIG. 1 is a perspective view illustrating a vehicle interior of a vehicle including a vehicular display device according to the present embodiment;

FIG. 2 is a front view illustrating a vehicular display device according to a first embodiment;

FIG. 3 is a planar cross-sectional view illustrating the vehicular display device according to the first embodiment;

FIG. 4A is a perspective view illustrating a display area of a diffusion plate configuring the vehicular display device according to the first embodiment;

FIG. 4B is a planar cross-sectional view illustrating a transparent resin plate to which the diffusion plate has been joined and an irradiation device, configuring the vehicular display device according to the first embodiment;

FIG. 5A is an explanatory view illustrating a step in which the transparent resin plate to which the diffusion plate has been joined is assembled to a base, configuring the vehicular display device according to the first embodiment;

FIG. 5B is an explanatory view illustrating a step in which a decoration film on which a light shielding film has been deposited is attached to the base, configuring the vehicular display device according to the first embodiment;

FIGS. 6A to 6C are planar cross-sectional views illustrating modified examples of assembly means by which the transparent resin plate to which the diffusion plate has been joined is assembled to the base, configuring the vehicular display device according to the first embodiment;

FIG. 7 is a planar cross-sectional view illustrating a state in which a metal panel has been attached to a base, configuring a vehicular display device according to a second embodiment; and

FIG. 8 is a planar cross-sectional view illustrating a state in which a diffusion plate including a light shielding film has been attached to a base, configuring a vehicular display device according to a third embodiment.

### DETAILED DESCRIPTION

Note that for convenience of description, an arrow UP, an arrow FR, and an arrow LH illustrated in each of the drawings are assumed to be, respectively, an upward direction of a vehicle body, a forward direction of the vehicle body, and a leftward direction of the vehicle body. Moreover, in the description below, when up-down, front-rear, and left-right directions are described without special mention, these are assumed to indicate, respectively, up-down in vertical direction of the vehicle body, front-rear in front-rear direction of the vehicle body, and left-right in left-right direction (a vehicle width direction) of the vehicle body.

### First Embodiment

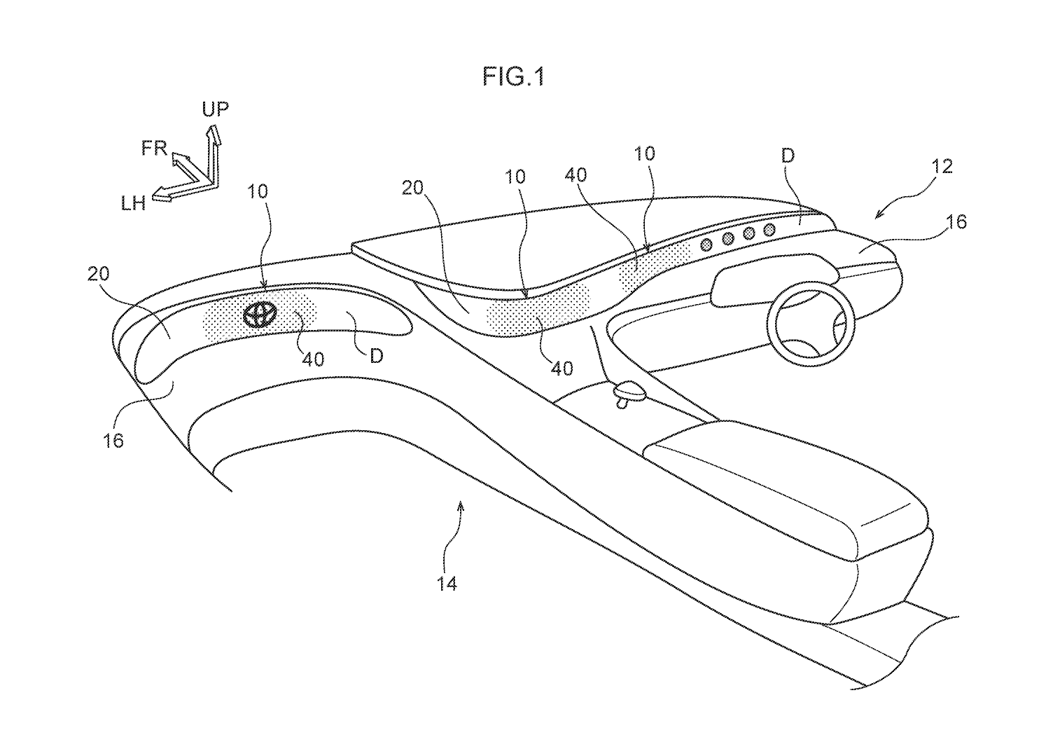

First, a vehicular display device 10 according to a first embodiment will be described. As illustrated in FIG. 1, the vehicular display device 10 according to the first embodiment includes a decoration panel 20 provided as an interior (decoration) in an instrument panel 16 on the inside of a vehicle interior 14 of a vehicle 12.

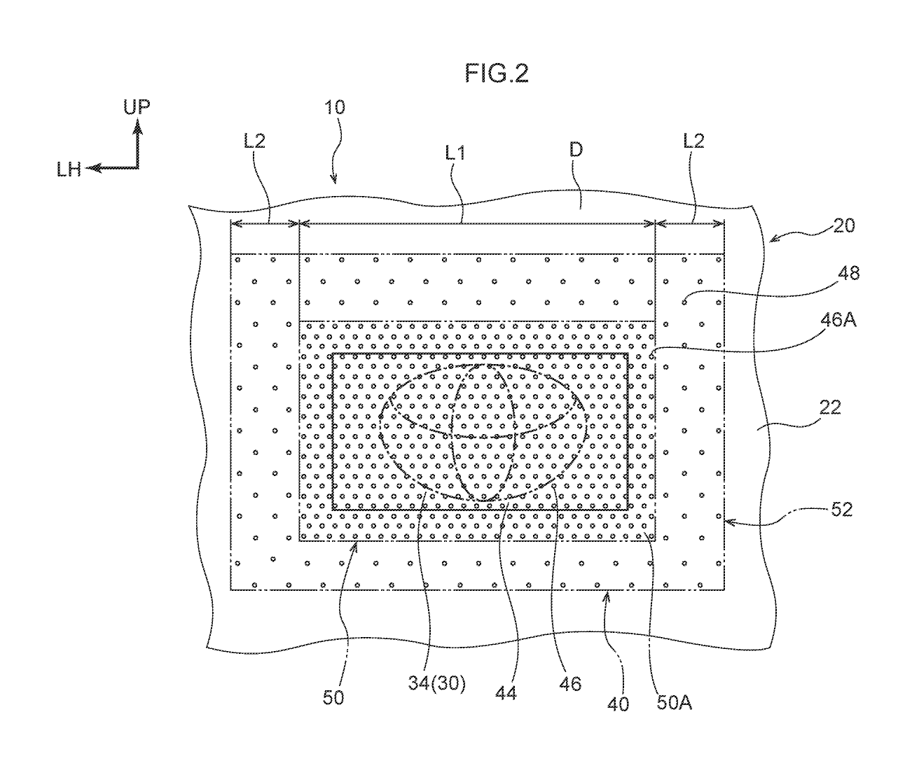

As illustrated in FIG. 2, the decoration panel 20 includes a base 22 made of a resin whose surface (one surface) exposed to the inside of the vehicle interior 14 is configured as a design surface D. Examples of a resin material employed in the base 22 include engineering plastics such as polypropylene (PP), acrylonitrile butadiene styrene (ABS), and polycarbonate (PC), for example.

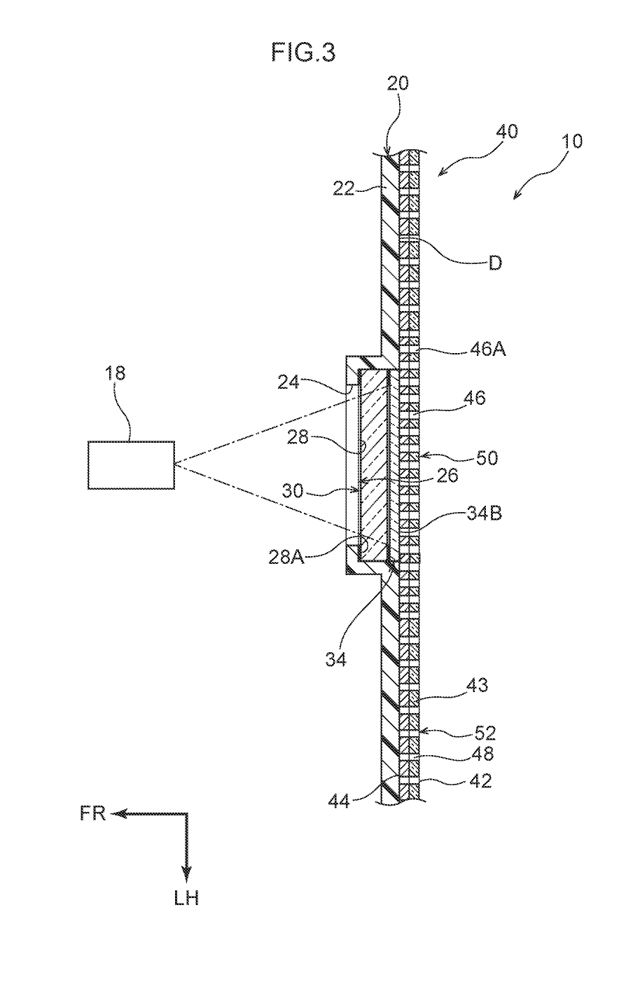

As illustrated in FIGS. 2 and 3, an opening 24 of a rectangular shape having as its longitudinal direction the vehicle width direction, for example, is formed at a certain position of the base 22. Describing in detail, a recess 26 of a rectangular shape having as its longitudinal direction the vehicle width direction, for example, is formed in the base 22 with a depth substantially identical to a plate thickness of a later-described transparent resin plate 30 and diffusion plate 34 overlaid, and the opening 24 of a rectangular shape slightly smaller than that of that recess 26 is formed in a bottom surface 28 of that recess 26. Moreover, the opening 24 is blocked by the transparent resin plate 30 acting as a transparent member.

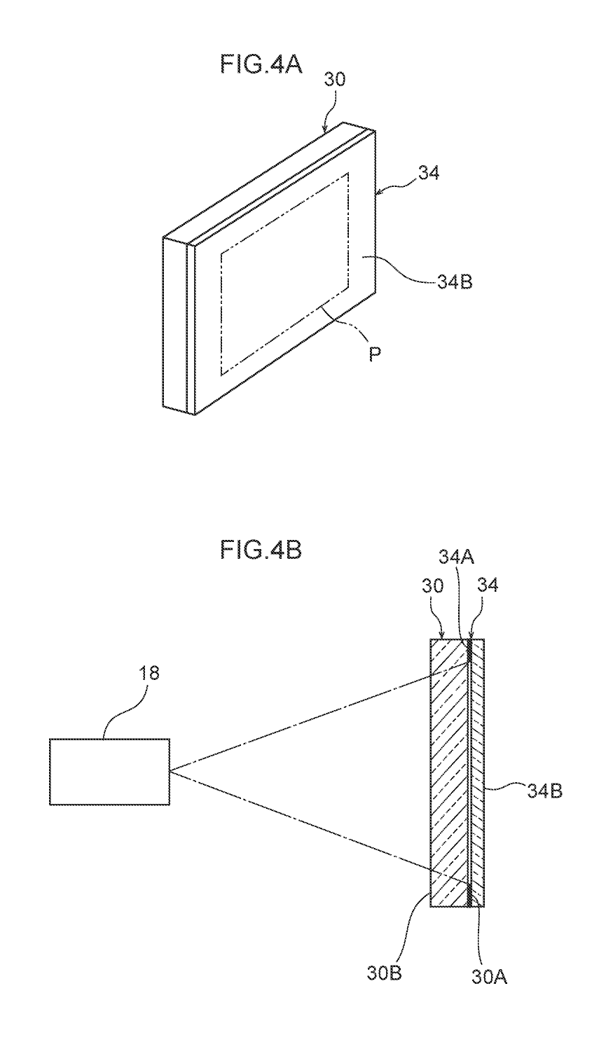

The transparent resin plate 30 is formed in a flat plate shape having a substantially identical shape to that of the recess 26 when viewed from a design surface D side of the base 22, by a transparent resin material such as polycarbonate or an acryl, for example. Moreover, as illustrated in FIGS. 3, 4A, and 4B, the diffusion plate 34 which is transparent, acts as a diffusion member, and is formed with a similar shape to that of the transparent resin plate 30 and in a flat plate shape having a plate thickness is smaller than that of the transparent resin plate 30, is overlaid on and joined to one surface of the transparent resin plate 30.

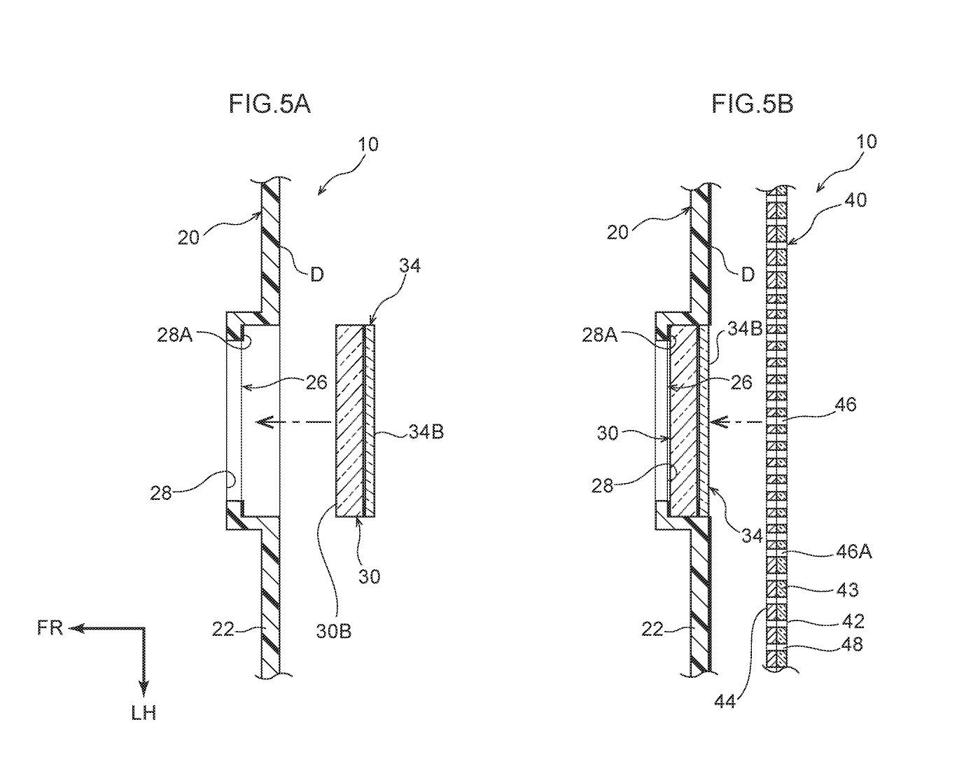

That is, a peripheral portion 34A in one surface of the diffusion plate 34 is overlaid on and joined, by an adhesive agent or double sided tape, to a peripheral part 30A in one surface of the transparent resin plate 30, and the transparent resin plate 30 and the diffusion plate 34 are integrated. Moreover, as illustrated in FIG. 5A, the transparent resin plate 30 to which the diffusion plate 34 has been joined is inserted inside the recess 26 from the design surface D side of the base 22, and a peripheral portion 30B in the other surface of that transparent resin plate 30 is joined, by an adhesive agent or the like, to a peripheral portion 28A in the bottom surface 28 of the recess 26.

As a result, in addition to the diffusion plate 34 being fixed to the base 22 via the transparent resin plate 30, the opening 24 is blocked by the diffusion plate 34 (in detail, the transparent resin plate 30 to which the diffusion plate 34 has been joined), and the other surface 34B of the diffusion plate 34 is made substantially flush with the design surface D of the base 22 thereby configuring part of that design surface D. Note that due to the opening 24 being blocked by the transparent resin plate 30 to which the diffusion plate 34 has been joined, there is a configuration securing rigidity of the base 22 where the opening 24 is formed.

In addition, as illustrated in FIGS. 2, 3, and 5B, a sheet member 40 of a rectangular shape having an area that is larger than that of the diffusion plate 34 (a later-described light transmission type screen portion 50) when viewed from the side of the design surface D of the base 22, is formed on that design surface D. The sheet member 40 is configured by a decoration film 42 acting as a light transmitting film on whose surface is printed a pattern 43 configuring an appropriate design, and by a light shielding film 44 deposited (attached) by vapor deposition or the like on a reverse side of the decoration film 42.

Moreover, numerous micropores 46 and later-described dummy micropores 48 that penetrate the decoration film 42 and the light shielding film 44 are formed, by laser processing, in the sheet member 40. Note that the micropores 46 and later-described dummy micropores 48 are both formed in a circular shape of the same diameter difficult to be seen by the naked eye, and that diameter is set to 30 μm, for example. These micropores 46 configure a light transmitting portion that transmits light, and the light shielding film 44 between the micropore 46 and the micropore 46 configures a light shielding portion that does not transmit light.

In other words, the sheet member 40 includes the light transmission type screen portion 50 (refer to FIG. 2) having mixed therein the numerous micropores 46 acting as the light transmitting portion configured such that light may be transmitted, and the light shielding film 44 acting as the light shielding portion configured such that light may not be transmitted. A light shielding film 44 side of the sheet member 40 is attached, by an adhesive agent or double sided tape, to part of the design surface D of the base 22, such that that light transmission type screen portion 50 covers the diffusion plate 34.

Note that as illustrated in FIG. 2, a region where the light transmission type screen portion 50 is formed is set in a range which is broader than the diffusion plate 34, and narrower than an external form of the sheet member 40. Therefore, there is a configuration in which light (an image) that has been transmitted through the transparent resin plate 30 and diffused by the diffusion plate 34 is not irradiated on a micropore 46A in a peripheral portion 50A of the light transmission type screen portion 50 protruding from the diffusion plate 34.

That is, the micropore 46A in the peripheral portion 50A of the light transmission type screen portion 50 protruding from the diffusion plate 34 is resultantly configured as a dummy micropore not irradiated by light (an image). Moreover, as illustrated in FIG. 2, a gradual variation portion 52 including plural dummy micropores 48 penetrating the decoration film 42 and the light shielding film 44 is provided, by laser processing, in a periphery (outside in-plane direction) of the light transmission type screen portion 50 of the sheet member 40.

Describing in detail, a pitch of the dummy micropores 48 in the gradual variation portion 52 is set to a pitch which is larger than a pitch of the micropores 46 in the light transmission type screen portion 50. Specifically, the micropores 46 (including the micropores 46A) in the light transmission type screen portion 50 covering the diffusion plate 34 and protruding from the diffusion plate 34 are formed with a first pitch of about 200 μm, for example.

On the other hand, the dummy micropores 48 in the gradual variation portion 52 are formed with a second pitch (of about 600 μm, for example) which is a pitch larger than the first pitch. As a result, in the design surface D of the decoration panel 20, a boundary between a region where the micropores 46 (including the micropores 46A) are formed and a region where the micropores 46 (including the micropores 46A) are not formed becomes indistinct.

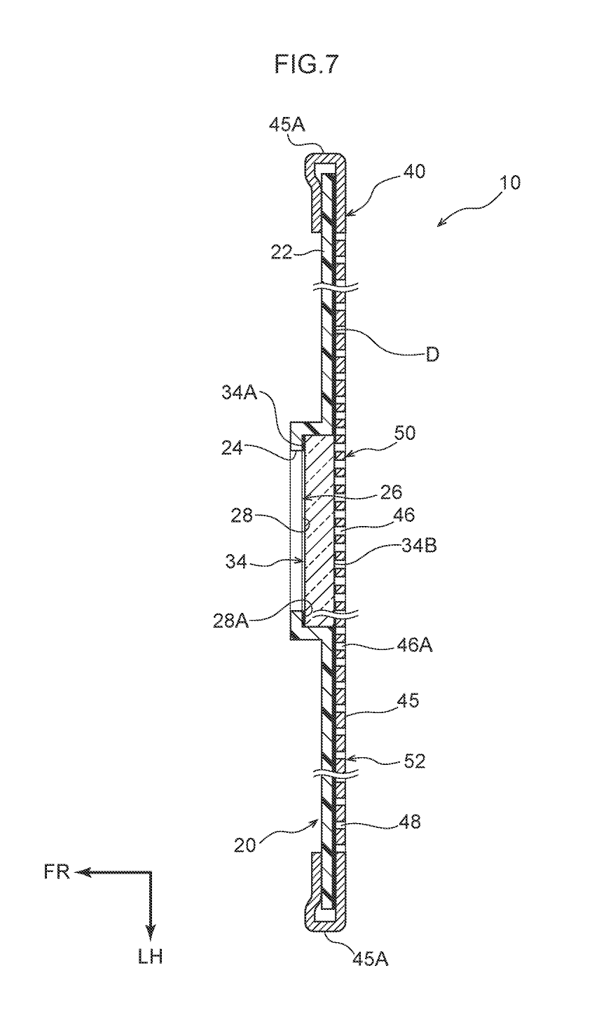

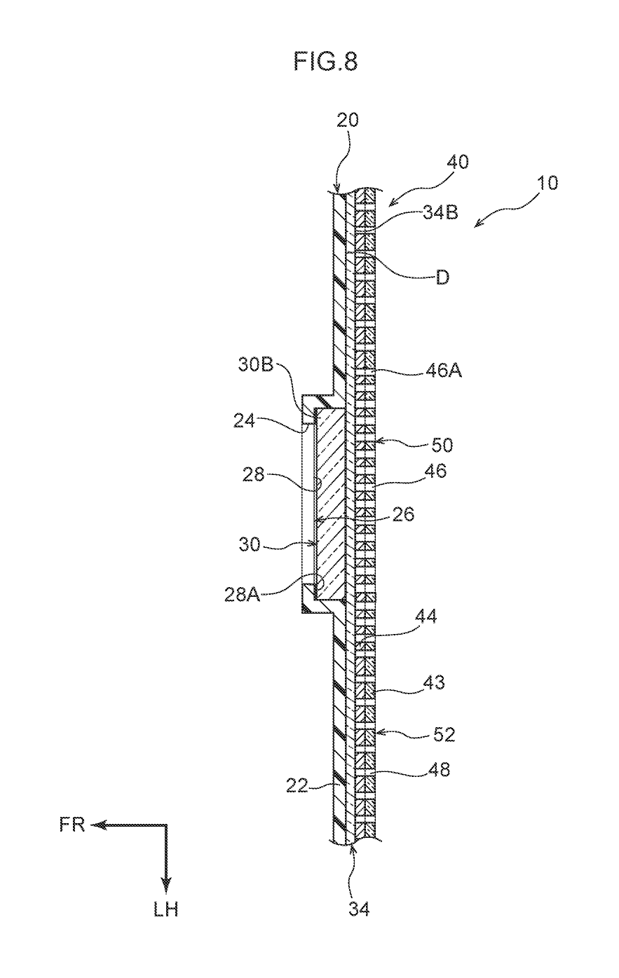

Note that although omitted from the drawings, the second pitch when forming the dummy micropores 48 is desirably configured as a pitch that gradually becomes larger with increasing distance from the diffusion plate 34. Moreover, for convenience of description, in FIGS. 2, 3, and 5B, and later-described FIGS. 7 and 8, the micropores 46 (including the micropores 46A) and the dummy micropores 48 are depicted expanded. Furthermore, in FIG. 1 also, an area where the sheet member 40 is attached is depicted expanded.

In addition, as illustrated in FIG. 2, the size of the gradual variation portion 52 is set to, for example, about approximately ¼ to ⅓ of a length L1 of the light transmission type screen portion 50, which is a length in a longitudinal direction of the light transmission type screen portion 50. Specifically, with respect to the length L1 in the longitudinal direction of the light transmission type screen portion 50 being set to, for example, 300 mm, a length L2 in the same direction of the gradual variation portion 52 is set to, for example, 50 mm each on both sides of the light transmission type screen portion 50, that is, to a total of 100 mm.

Moreover, as illustrated in FIGS. 3 and 4B, an irradiation device (projector) 18 that irradiates with light (an image) the transparent resin plate 30 to which the diffusion plate 34 has been joined blocking the opening 24, from a side of the opening 24, is arranged on a vehicle body configuration component (omitted from the drawings) of the vehicle 12 on a reverse (other surface) side of the base 22. Note that ON/OFF of the irradiation device 18 is performed by an occupant operating a switch (omitted from the drawings) provided in the likes of the instrument panel 16.

Moreover, light (an image) irradiated from the irradiation device 18 is configured to pass through the opening 24, and to be transmitted through and diffused by an inside region, excluding the peripheral portions 30A and 34A, which are the joining region of the transparent resin plate 30 and the diffusion plate 34. The inside region excluding the peripheral portions 30A and 34A of the transparent plate 30 and the diffusion plate 34 configures a display area P (refer to FIG. 4A) where the light is transmitted (the image is projected). Hence, the display area P is configured as a slightly smaller area than the diffusion plate 34.

Next, operation of the vehicular display device 10 according to the first embodiment configured as above, will be described.

When light is not irradiated (i.e., the image is not projected) from the irradiation device 18, the decoration film 42 in the sheet member 40, which has the numerous micropores 46 (including the micropores 46A) and the plural dummy micropores 48 formed therein, and which is provided so as to cover the diffusion plate 34 configures part of the design surface D of the decoration panel 20, in conjunction with the design surface D.

On the other hand, when light has been irradiated (i.e., the image has been projected) from the irradiation device 18, the image or an illumination are displayed on the part of the design surface D of the decoration panel 20, that is, on the light transmission type screen portion 50 of the sheet member 40, due to the light that has been transmitted through the display area P of the diffusion plate 34 and transmitted through the numerous micropores 46 of the sheet member 40.

Thus, as a result of the vehicular display device 10 according to the present embodiment, in the decoration panel 20, when light is not irradiated (i.e., the image is not projected) from the reverse side of the base 22, the decoration film 42 of the sheet member 40 configures the part of the design surface D, and when light has been irradiated (i.e., the image has been projected) from the reverse side of the base 22, the light transmission type screen portion 50 of the sheet member 40 configuring the part of the design surface D becomes a screen and may thereby display the image or an illumination.

In other words, as a result of the vehicular display device 10 according to the present embodiment, in the midst of a display provided inside the vehicle interior 14 increasing in size and becoming more complex, it may be made less easy to sense that the display (the light transmission type screen portion 50) is present on the inside of the vehicle interior 14. Examples of images displayed on the light transmission type screen portion 50 include the logo illustrated in FIG. 2 or an unillustrated indicator, for example. Moreover, the sheet member 40 has a configuration of being attached to the design surface D of the base 22 of the decoration panel 20, hence its rigidity is secured.

Moreover, in the sheet member 40, the region where the light transmission type screen portion 50 is formed is set in a range which is broader than the diffusion plate 34, and narrower than an external form of the sheet member 40. In other words, the region where the numerous micropores 46 (including the micropores 46A) are formed is set in a range which is broader than the diffusion plate 34, and narrower than an external form of the sheet member 40. Therefore, the sheet member 40 may be manufactured at lower cost, compared to a configuration in which the numerous micropores 46 are formed on an entire surface of the sheet member 40.

Moreover, by making the formation region of the light transmission type screen portion 50 broader than the diffusion plate 34, even if an attachment position of the sheet member 40 is somewhat misaligned when it is attached to the design surface D of the base 22, the diffusion plate 34 is reliably covered by the light transmission type screen portion 50. Therefore, even the decoration panel 20 to which the sheet member 40 is attached has its positional accuracy relaxed, and is thus easily manufactured.

Moreover, the gradual variation portion 52 including the dummy micropores 48 that are formed with the second pitch, which is larger than the first pitch with which the micropores 46 are formed, is provided in the sheet member 40 in the periphery (outside in-plane direction) of the light transmission type screen portion 50. Therefore, the boundary between the region where the micropores 46 are formed and the region where the micropores 46 are not formed may be made indistinct when viewed from the design surface D side of the base 22. Hence, impairment of appearance of the design surface D of the decoration panel 20 may be suppressed.

Moreover, by making the second pitch when forming the dummy micropores 48 larger with increasing distance from the diffusion plate 34, the boundary between the region where the micropores 46 are formed and the region where the micropores 46 are not formed may be made even more indistinct when viewed from the design surface D side of the base 22. Hence, impairment of appearance of the design surface D of the decoration panel 20 may be even more suppressed.

Moreover, by making the second pitch with which the dummy micropores 48 are formed larger than the first pitch with which the micropores 46 are formed, labor saving is made in the laser processing for forming the dummy micropores 48 itself. Hence, a cost for manufacturing the sheet member 40 (forming the dummy micropores 48) may be reduced. Moreover, the diffusion plate 34 is made substantially flush with the design surface D of the base 22. In other words, the design surface D of the decoration panel 20 including the display area P is configured as a stepless substantially smooth surface. Therefore, appearance of the design surface D of the decoration panel 20 may be improved.

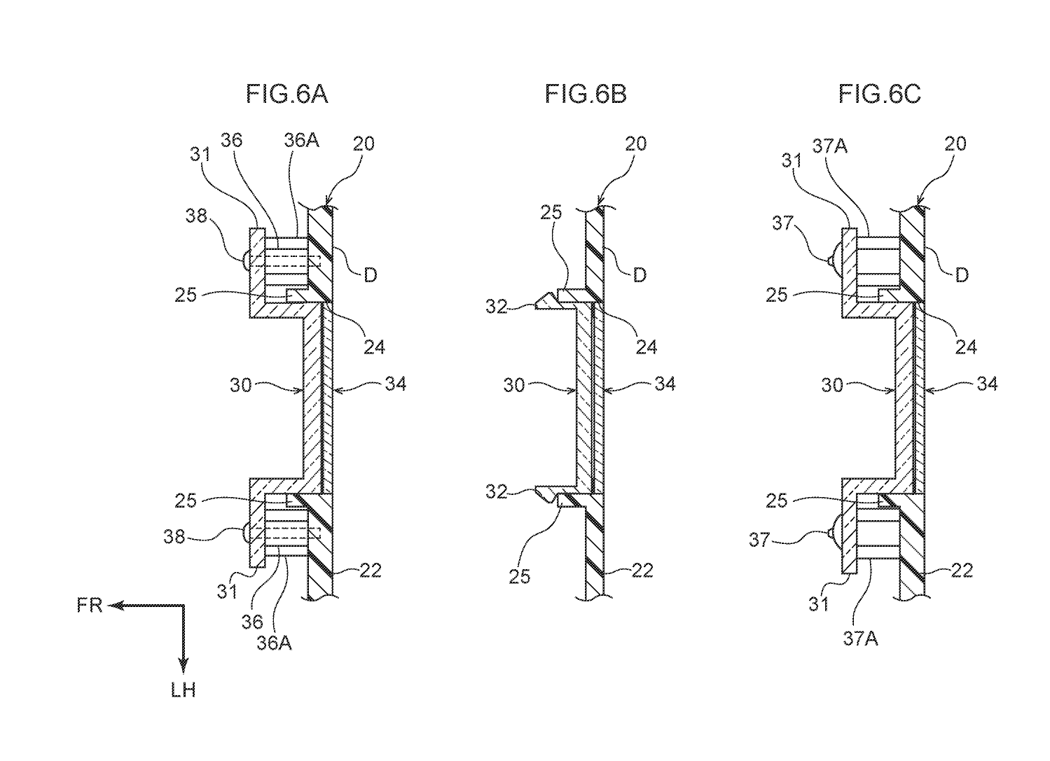

Note that the method of fixing the transparent resin plate 30 to which the diffusion plate 34 has been joined to the opening 24 of the base 22 is not limited to the method of fixing illustrated in FIG. 5A, and may be configured as methods of fixing as illustrated in FIGS. 6A to 6C, for example. In these cases, as illustrated in FIGS. 6A to 6C, only the opening 24, not the recess 26, is formed in the base 22, and a peripheral wall 25 projecting to a reverse side of the base 22 is formed in a peripheral part of that opening 24. Rigidity around the opening 24 is secured by this peripheral wall 25.

Describing the cases individually, in the method of fixing illustrated in FIG. 6A, the transparent resin plate 30 is formed in a substantially hat-like shape in planar cross-sectional view, and a through hole (omitted from the drawings) is formed in each of flanges 31. Moreover, a boss 36 of substantially cylindrical shape projecting to the reverse side of the base 22 is formed integrally in the reverse of the base 22, and a positioning rib 36A having a substantially cross-like shape when viewed from an axial direction of the boss 36 is formed on an outer peripheral surface of that boss 36.

Therefore, by a screw 38 being inserted in the through hole of each flange 31 and in a through hole (omitted from the drawings) of the boss 36 and being screwed into the reverse of the base 22, the transparent resin plate 30 is fixed to the base 22. Moreover, by each flange 31 abutting on the positioning rib 36A, the diffusion plate 34 is positioned so as to be substantially flush with the design surface D of the base 22.

In the method of fixing illustrated in FIG. 6B, there is a configuration in which a claw part 32 projecting to the reverse side of the base 22 is formed integrally at both ends in a longitudinal direction in the other surface of the transparent resin plate 30, and the claw part 32 is fixed by being locked to an extremity of the peripheral wall 25. That is, the transparent resin plate 30 is inserted in the opening 24 from the design surface D side while the claw part 32 is being elastically (flexibly) deformed toward the inner side in the longitudinal direction. Thereupon, the claw part 32, on passing beyond the peripheral wall 25, is restored to its original state and is locked to the extremity of the peripheral wall 25. As a result, the transparent resin plate 30 is fixed to the base 22, and the diffusion plate 34 is positioned so as to be substantially flush with the design surface D of the base 22.

In the method of fixing illustrated in FIG. 6C, the transparent resin plate 30 is formed in a substantially hat-like shape in planar cross-sectional view, and a through hole (omitted from the drawings) is formed in each of flanges 31. Moreover, a pin 37 of substantially circular columnar shape projecting toward the reverse side of the base 22 is formed integrally in the reverse of the base 22, and a positioning rib 37A having a substantially cross-like shape when viewed from an axial direction of the pin 37 is formed on an outer peripheral surface of that pin 37.

Therefore, by the pin 37 being inserted in the through hole of each flange 31 and an extremity of the pin 37 projecting from the through hole of each flange 31 being heated and caulked (crushed), the transparent resin plate 30 is fixed to the base 22. Moreover, by each flange 31 abutting on the positioning rib 37A, the diffusion plate 34 is positioned so as to be substantially flush with the design surface D of the base 22.

### Second Embodiment

Next, a vehicular display device 10 according to the second embodiment will be described. Note that components equivalent to in the above-described first embodiment are assigned with the same symbols as in the first embodiment, and detailed descriptions (including also shared operations) of those components will be omitted.

As illustrated in FIG. 7, in the vehicular display device 10 according to the second embodiment, the opening 24 is blocked by the diffusion plate 34 only. That is, the diffusion plate 34 is inserted inside the recess 26 from the design surface D side of the base 22, and the peripheral portion 34A in one surface of the diffusion plate 34 is joined, by an adhesive agent or the like, to the peripheral portion 28A in the bottom surface 28 of the recess 26.

As a result, the diffusion plate 34 being fixed to the base 22, and the other surface 34B of the diffusion plate 34 is made substantially flush with the design surface D of the base 22 thereby configuring part of that design surface D. Moreover, in the vehicular display device 10 according to this second embodiment, the sheet member 40 is configured by a panel (referred to below as “metal panel”) 45 made of a metal such as aluminum or titanium (including an alloy).

That is, the numerous micropores 46 (including the micropores 46A) and the plural dummy micropores 48 are formed, by laser processing, in the metal panel 45, and similarly to in the above-described first embodiment, the light transmission type screen portion 50 and the gradual variation portion 52 are formed in the metal panel 45. Moreover, those micropores 46 configure the light transmitting portion that transmits light, and the metal panel 45 between the micropores 46 configures the light shielding portion that does not transmit light.

In this way, equivalent operational effects to those of the above-described first embodiment are obtained even in the case in which the sheet member 40 is configured by the metal panel 45. Moreover, by configuring the sheet member 40 by the metal panel 45, compared to the case of configuring the sheet member 40 by depositing the light shielding film 44 on the decoration film 42 having light transmitting properties, rigidity of the sheet member 40 may be more improved, and since the step of depositing the light shielding film 44 is unnecessary, the sheet member 40 may be more easily formed.

Note that a pattern, and so on, similar to that of the decoration film 42 in the above-described first embodiment may be directly printed on the surface of the metal panel 45 exposed to the inside of the vehicle interior 14. Moreover, although the metal panel 45 is attached to the design surface D of the base 22 by an adhesive agent, double sided tape or the like, there may be a configuration in which its both ends 45A in a longitudinal direction are fixed by being doubled back so as to clasp both ends in a longitudinal direction of the base 22.

### Third Embodiment

Next, a vehicular display device 10 according to the third embodiment will be described. Note that components equivalent to in the above-described first embodiment are assigned with the same symbols as in the first embodiment, and detailed descriptions (including also shared operations) of those components will be omitted.

As illustrated in FIG. 8, in the vehicular display device 10 according to the third embodiment, the opening 24 is blocked by the transparent resin plate 30 only. That is, the transparent resin plate 30 is inserted inside the recess 26 from the design surface D side of the base 22, and the peripheral portion 30B in the other surface of that transparent resin plate 30 is joined to the peripheral portion 28A in the bottom surface 28 of the recess 26, by an adhesive agent or the like.

As a result, the transparent resin plate 30 is fixed to the base 22, and one surface of the transparent resin plate 30 is made substantially flush with the design surface D of the base 22 thereby configuring part of that design surface D. Moreover, in the vehicular display device 10 according to the third embodiment, the sheet member 40 is configured by the diffusion plate 34 on which the light shielding film 44 and the pattern 43, and so on, are printed.

That is, the (black) light shielding film 44 including the micropores 46 (including the micropores 46A) and the dummy micropores 48 is directly printed on the other surface 34B of the diffusion plate 34 that is formed with substantially the same size as the sheet member 40, and the pattern 43, and so on, similar to that of the decoration film 42 in the above-described first embodiment is directly printed on that light shielding film 44.

As a result, the light transmission type screen portion 50 and the gradual variation portion 52 similar to those of the above-described first embodiment are formed on the other surface 34B of the diffusion plate 34. Moreover, a peripheral portion in one surface of the diffusion plate 34 is attached to the design surface D of the base 22, by an adhesive agent or double sided tape, such that that diffusion plate 34 covers the transparent resin plate 30.

In this way, equivalent operational effects to those of the above-described first embodiment are obtained even when the sheet member 40 is configured by the diffusion plate 34. By configuring the sheet member 40 by the diffusion plate 34, rigidity of the sheet member 40 may be more improved compared to the case of configuring the sheet member 40 by depositing the light shielding film 44 on the decoration film 42 having light transmitting properties.

The vehicular display device 10 according to the embodiments have been described above based on the drawings. However, the vehicular display device 10 according to the embodiments is not limited to what is illustrated in the drawings, and may undergo appropriate design changes within a range not departing from the gist of the present disclosure. For example, the first and third embodiments may adopt a configuration in which an unillustrated Fresnel lens, microlens or the like is provided between the transparent resin plate 30 and the diffusion plate 34.

In addition, the second embodiment may be configured such that the transparent resin plate 30 is provided similarly to in the first embodiment. Moreover, in the first and second embodiments, the light transmission type screen portion 50 may be formed with substantially the same size as the diffusion plate 34. Furthermore, the shape of the diffusion plate 34 or the shape of the light transmission type screen portion 50 is not limited to the rectangular shape as illustrated in the drawings, and may be formed in, for example, a circular shape, an elliptical shape or the like when viewed from the design surface D side of the decoration panel 20, although this is not illustrated in the drawings.

Moreover, although the gradual variation portion 52 illustrated in the drawings is provided in a periphery of the light transmission type screen portion 50, embodiments are not limited to this, and may have a configuration in which it is provided only on both sides in a longitudinal direction of the light transmission type screen portion 50, for example. Moreover, the diameter or pitch of the micropores 46 (including the micropores 46A) and the dummy micropores 48 that are difficult to be seen with the naked eye are not limited to the above-described numerical values.

In addition, the light transmitting portion according to the first embodiment is not limited to the micropores 46 penetrating the decoration film 42 and the light shielding film 44, and may be configured by a micropores (omitted from the drawings) penetrating only the light shielding film 44. In other words, it is possible to configure such that light (an image) that has been transmitted through the transparent resin plate 30 and diffused by the diffusion plate 34 is transmitted through the decoration film 42 and thereby displayed. Moreover, the vehicular display device 10 according to the present embodiment may be applied not only to an ordinary vehicle that runs by being driven by a driver, but also to an automatic drive vehicle that runs automatically without being driven by a driver.

What is claimed is:

1. A vehicular display device comprising:
a decoration panel that includes a base, the base including one surface thereof configured as a design surface and the base including an opening formed therein, and the decoration panel being provided at an interior in a vehicle;
a diffusion member that is configured to block the opening of the base; and
a sheet member that includes a light transmission type screen portion, the light transmission type screen portion including a light transmitting portion and a light shielding portion mixed therein, the light transmitting portion being configured such that light that has been irradiated from a side of another surface of the base to be diffused by the diffusion member is transmitted, and the light shielding portion being configured such that the light cannot be transmitted, and the sheet member being provided on the design surface such that the light transmission type screen portion covers the diffusion member.

2. The vehicular display device according to claim 1, wherein
a region where the light transmission type screen portion is formed is in a range that is broader than the diffusion member and narrower than an external form of the sheet member.

3. The vehicular display device according to claim 2, wherein
the sheet member is configured by a light shielding film being deposited on a light transmitting film,
the light transmitting portion is configured by numerous micropores that penetrate the light transmitting film and the light shielding film, and
the light shielding portion is configured by the light shielding film.

4. The vehicular display device according to claim 2, wherein
the sheet member is configured by a panel made of a metal,
the light transmitting portion is configured by numerous micropores that penetrate the panel, and
the light shielding portion is configured by the panel.

5. The vehicular display device according to claim 3, wherein
the sheet member includes a gradual variation portion that includes a plurality of dummy micropores formed with a pitch larger than that of the micropores, at a periphery of the light transmission type screen portion.

6. The vehicular display device according to claim 5, wherein
a pitch of the dummy micropores is made larger with increasing distance from the diffusion member.

7. The vehicular display device according to any of claim 1, wherein
the diffusion member is made flush with the design surface of the base.

8. A vehicular display device comprising:
a decoration panel that includes a base, the base including one surface thereof configured as a design surface and the base including an opening formed therein, and the decoration panel being provided at an interior in a vehicle;
a transparent member that is configured to block the opening of the base; and
a diffusion member that includes a light transmission type screen portion, the light transmission type screen portion including a light transmitting portion and a light shielding portion mixed therein, the light transmitting portion being configured such that light that has been irradiated from a side of another surface of the base to be transmitted through the transparent member is diffused and the diffused light is transmitted, and the light shielding portion being configured such that the light cannot be transmitted, and the diffusion member being provided on the design surface such that the light transmission type screen portion covers the transparent member.
